(19) United States
(12) Patent Application Publication
(10) Pub. No.: US 2006/0059744 A1
(43) Pub. Date: Mar. 23, 2006

(54) Method for displaying a waterproof poster board

(76) Inventors: Catherine H. Wescott, Beavercreek, OH (US); Thomas S. Walker, Kettering, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/943,303

(22) Filed: Sep. 17, 2004

(51) Int. Cl. G09F 7/00

(52) U.S. Cl. 40/584

(57) ABSTRACT

A method for display including the steps of providing a sheet-like poster board substantially composed of a non-water absorbent material and including a first display surface and a second display surface. The first display surface and the second display surface lack any attachment structures located thereon. The method further includes the step of manually making non-soluble markings on the first surface to provide water-resistant markings on the first surface, and displaying the poster board in an environment having a significant likelihood of exposure to liquids.

### FIELD

The present invention is directed to a poster board display system, and more particularly, to a waterproof poster board display system.

### BACKGROUND

Business enterprises, individuals, schools and other organizations often use poster boards as a means of communication and decoration, as well as for advertisements, presentations and artwork. Poster boards are typically used for temporary display and are frequently attached to a mounting surface. Users may manually mark or draw on the poster boards to create a personalized or individualized display. However, many existing poster boards may be damaged by exposure to liquids, such as water.

Accordingly, there is a need for a poster board that is waterproof or is not damaged by moisture.

### SUMMARY

The present invention utilizes a poster board of polymeric or non-moisture absorbent or non-water absorbent material. In particular, one embodiment of the invention is a method for display including the steps of providing a sheet-like poster board substantially composed of a non-water absorbent material and including a first display surface and a second display surface. The first display surface and the second display surface lack any attachment structures located thereon. The method further includes the step of manually making non-soluble markings on the first surface to provide water-resistant markings on the first surface, and displaying the poster board in an environment having a significant likelihood of exposure to liquids.

### BRIEF DESCRIPTION OF THE DRAWINGS

FIG. 1 is a front view of one embodiment of the poster board, shown on a mounting surface; and

FIG. 2 is a back view of the poster board of FIG. 1.

### DETAILED DESCRIPTION

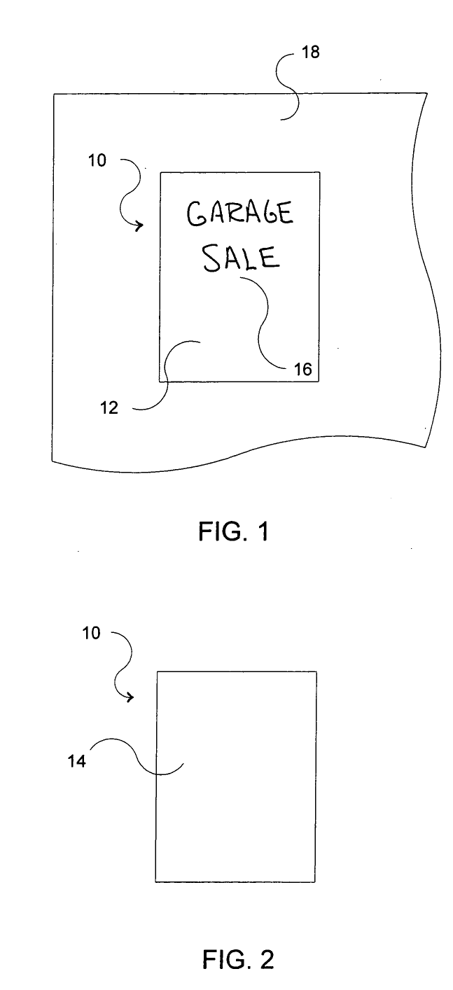

Referring to FIGS. 1 and 2, in one embodiment the poster board 10 includes a front surface 12 and a back surface 14 located on opposite sides of the poster board 10. The front surface 12 and back surface 14 may be substantially identical in size and shape. A user may utilize the front surface 12, the back surface 14 or both the front 12 and back 14 surfaces for marking. In one embodiment, both the front surface 12 and the back surface 14 of the poster board 10 have no attachment structures (such as hook-and-loop material (i.e., VELCRO®), adhesives clips, or the like) located therein. The front 12 and back 14 surfaces may also have no additional components or structures located thereon and thus may be cleanly presented so that they are entirely available to the user for marking thereon. This provides the user with the maximum surface area on which to create a display.

The poster board 10 may be made out of sheet stock of any suitable plastic or polymeric material, such as a polyethylene. In one embodiment, the poster board 10 is entirely composed of STACON® plastic sheets, commercially available from CSP, Inc. of St. Louis, Mo. When the poster board 10 is composed entirely of a plastic, a non-water absorbent material, the poster board 10 may be effectively waterproof so that the poster board 10 may not warp, deform or wilt in intense humidity, damp conditions or even in direct contact with water. A user may utilize a permanent marker, grease pencil, non-water soluble marking device or other marking device intended for marking on non-absorbent materials to mark or draw upon the poster board 10. In particular, markings 16 made by permanent markers and grease pencils are substantially unaffected by water.

In addition, utilizing a plastic material for the poster board 10 provides a durable display system such that the poster board 10 may not easily tear or rip. In addition, many adhesives, such as tape, which may be used to attach the poster board to a mounting surface 18 may be removed from a plastic poster board 10 without damaging the poster board 10. Also, if the poster board 10 becomes spattered or covered with mud, dirt or dust, a damp rag may be used to clean the front surface 12 and back surface 14 of the poster board 10 without adversely affecting the markings 16 or the poster board 10.

In one embodiment the poster board 10 is composed entirely of plastic material. Using only plastic materials for the poster board 10, rather than using a layer of plastic covering water-absorbent materials, ensures that any cracks or gouges in the front or back surfaces 12, 14 of the poster board 10 will not affect the waterproof nature of the poster board 10. When the poster board 10 is made of plastic through its entire thickness, a crack or disruption in the front or back surfaces 12, 14 would not compromise the non-absorbent nature of the poster board 10 to water.

The poster board 10 may be rectangular in front view and may have a variety of sizes, for example about 11 inches×14 inches, about 22 inches×28 inches or about 24 inches×36 inches. However, the poster board 10 may be any size or shape suitable for display and communication of information. Because the poster board 10 may be entirely composed of plastic, the user may cut or trim the poster board 10 to a desired shape without the affecting waterproof nature of the poster board 10.

The front surface 12 and the back surface 14 of the poster board 10 may be white, colored or multi-colored. The poster board 10 may also be transparent, which allows a user to display the poster board 10 while minimizing obstruction of any mounting surface 18 or background in front of which the poster board 10 is displayed. A user may also utilize transparent poster board 10 to create one or more overlays for use with a non-transparent poster board 10 and other display.

The poster board 10 may be a variety of thickness, including but not limited to, about 0.12 inches or less, 0.23 inches or less, 0.35 inches or less, 0.55 inches or less or about 0.75 inches or less. In one embodiment, the poster board 10 may be relatively thin, with a thickness of between about 0.010 inches and about 0.020 inches. The thinness of the poster board 10 may provide several advantages. Large quantities of the poster board 10 may be more easily stored and shipped. In addition, the relatively thin poster board 10 may have a relatively light weight, making it easy to mount or attach to a mounting surface 18. For example, where an adhesive is utilized to attach the poster board 10 to a mounting surface 18, a relatively small amount of adhesive may be required due to the light weight of the poster board 10. Thus the strong nature of plastic allows the board to be thin yet durable.

The poster board 10 may also be flexible. This would allow the poster board 10 to be rolled for shipment and storage. The thinness and resulting flexibility of the poster board 10 may also allow the poster board 10 to be mounted on non-planar or curved surfaces.

To utilize the poster board 10, a user may first write, draw or mark on the display surface 12 of the poster board 10 using a marking device that creates non-water soluble marks, including but not limited to permanent markers and grease pencils, thereby creating water resistent or non-water soluble markings 16. The user may then display the poster board in a wide variety of ways. The poster board may be mounted to a wall, door or other mounting surface 18 using adhesives, magnets, push pins, nails and other methods widely known in the art. Alternatively, the user may attach the poster board to a support structure, or to one or more stakes inserted into the ground. The user may display the poster board such that both the front surface 12 and the back surface 14 are visible to those passing by. The user may also choose to display the poster board 10 by hand. For example, the poster board may be held by an individual advertising events such as car washes, where exposure to water is highly likely. Because of its durable and water proof nature the poster board 10 may be particularly useful for outdoor signs. The poster board 10 may be displayed outside, exposed to the elements such as rain, fog, snow, humidity and the like, while maintaining its shape and the markings 16 thereon. In particular, the poster board 10 may be utilized to create signs for garage sales, open houses and the like.

In an alternate embodiment, the front surface 12, back surface 14 or both may include pre-printed graphics located thereon. For example, the front surface 12 may be pre-printed with various text, drawings or indicia such as a calendar grid, common phrases such as “For Sale,” or a common design such as party balloons. The user may manually supplement the pre-printed indicia and manually add specific information such as event dates, prices or event information to the front surface 12.

The device and method shown herein allows a user to manually mark a poster board and display the poster board. The poster board is durable, waterproof and will be unaffected by humidity, damp conditions, rain, water spray and the like.

While particular embodiments of the present invention have been illustrated and described, it would be obvious to those skilled in the art that various additional changes and modifications can be made without departing from the spirit and scope of the present invention. It is therefore intended to cover in the appended claims all such changes and modifications that are within the scope of this invention.

What is claimed:

1. A method for display comprising the steps of:
providing a sheet-like poster board substantially composed of a non-water absorbent material and including a first display surface and a second display surface, wherein the first display surface and the second display surface lack any attachment structures located thereon;
manually making non-soluble markings on said first surface to provide water-resistant markings on said first surface; and
displaying said poster board in an environment having a significant likelihood of exposure to liquids.

2. The method of claim 1 wherein no other components are located on said first and second display surfaces.

3. The method of claim 1 wherein the first display surface and the second surface are cleanly presented such that no other components are located on said first and second display surfaces.

4. The method of claim 1 wherein the poster board is substantially composed of a polymeric material.

5. The method of claim 1 further comprising the step of manually making non-soluble markings on said second surface to provide water-resistant markings on said second surface.

6. The method of claim 1 wherein the poster board is non-white.

7. The method of claim 1 wherein the poster board is substantially transparent.

8. The method of claim 1 wherein the first display surface includes preprinted graphics located thereon.

9. The method of claim 8 wherein the second display surface includes preprinted graphics located thereon.

10. The method of claim 1 wherein the poster board is substantially rectangular and has dimensions of: about 8½ inches×11 inches, about 11 inches×14 inches, about 22 inches×28 inches or about 24 inches×36 inches.

11. The method of claim 1 wherein the poster board has a thickness between about 0.010 inches and about 0.075 inches.

12. The method of claim 1 wherein the marking step occurs prior to the placing step.

13. The method of claim 1 wherein the placing step occurs prior to the marking step.

14. The method of claim 1 wherein the marking step is carried out using a permanent ink marking device.

15. The method of claim 1 wherein the marking step is carried out using a grease pencil.

16. The method of claim 1 wherein the attachment structures include hook-and-loop fastening material.

17. The method of claim 1 wherein the attachment structures includes hook-and-loop fastening material, adhesives and clips.

18. The method of claim 1 wherein said displaying step includes displaying said poster board in an outdoor environment.

19. The method of claim 1 wherein polymeric material is STACON® plastic sheets.

20. The method of claim 1 wherein said sheet-like posterboard is made of non-water absorbent material substantially through its entire thickness.

21. A method for display comprising the steps of:
providing a sheet-like poster board including a first display surface and a second display surface, where the first display surface and the second display surface are cleanly presented such that no other components are located on said first and second display surfaces, the poster board having a thickness of between about 0.010 inches and 0.020 inches, and the poster board is substantially composed of a polymeric material;
manually marking on said first surface utilizing a permanent marking device to provide water-resistant markings on said first surface; and
coupling said poster board to a support structure located in outdoor environment with a significant likelihood of exposure to water such that said poster board and said water-resistant markings can withstand exposure to said water.
